(19) United States
(12) Patent Application Publication
(10) Pub. No.: US 2021/0195135 A1
(43) Pub. Date: Jun. 24, 2021

(54) VEHICLE RECORDING SYSTEMS AND METHODS

(71) Applicant: FEV North America, Inc., Auburn Hills, MI (US)

(72) Inventor: Norman Kaddis, Rochester Hills, MI (US)

(21) Appl. No.: 16/722,882

(22) Filed: Dec. 20, 2019

(51) Int. Cl. H04N 5/77; H04N 7/18

(52) U.S. Cl. CPC H04N 5/77; H04N 7/18

(57) ABSTRACT

A vehicle recording system is provided. The vehicle recording system includes a first camera, a data memory device, a first controller and a second controller. The first camera records a video or image data of an area of a vehicle surrounding environment. The data memory device stores the video or image data. The first controller controls, dependent on a signal from an advanced driver assistance system, the area of the vehicle environment captured by the first camera, writing of the video and/or image data onto the data memory device and reading the video and/or image data from the data memory device. The second controller control, dependent on an input from a vehicle occupant, the area of the vehicle environment captured by the first camera, writing the video and/or image data onto the data memory device and reading the video and/or image data from the data memory device.

### TECHNICAL FIELD

The present specification generally relates to a vehicle, and, more specifically, to the vehicle having a vehicle recording system.

### BACKGROUND

In recent years, many vehicles now include advanced driver assistance systems to assist drivers. These systems include electronic controllers and an increased number of cameras, such as front and/or rear cameras, and record video and/or image data of areas of a vehicle surrounding environment. However, these cameras are typically configured to only fulfill a single purpose, such as assisting a user during a parking process or measuring distances to preceding vehicles.

Further, it is generally known to capture data while a vehicle is driving, or is non-stationary, such as position information to detect a point of a road. As such, a road image is obtained, lanes of the road represented on the obtained road image are recognized, and a point of a road and lane in which the vehicle is traveling is detected such that traffic information for each lane and surrounding information at the detected point of the road may be displayed to the driver. However, this data is continuously overwritten as the car travels such that new traffic information may be provided.

Accordingly, a need exists for a video or image data to be captured, based on an input from a vehicle occupant, of an area of a vehicle environment and where a loss of video or image data from cameras controlled by the advanced driver assistance systems is prevented such that the preserved video or image data may be recalled later.

### SUMMARY

In one embodiment, a vehicle recording system is provided. The vehicle recording system includes a first camera, a data memory device, a first controller and a second controller. The first camera records a video or image data of an area of a vehicle surrounding environment. The data memory device stores the video or image data. The first controller controls, dependent on a signal from an advanced driver assistance system, the area of the vehicle environment captured by the first camera, writing of the video and/or image data onto the data memory device and reading the video and/or image data from the data memory device. The second controller control, dependent on an input from a vehicle occupant, the area of the vehicle environment captured by the first camera, writing the video and/or image data onto the data memory device and reading the video and/or image data from the data memory device.

In another embodiment, a method of operating a vehicle recording system is provided. The method includes recording a video or image data of an area of a vehicle surrounding environment, writing the video or image data onto a data memory device and reading video or image data from the data memory device. Wherein the recording, writing and reading are controlled by a first or second controller, dependent on a signal from an advanced driver assistance system and/or an input from a vehicle occupant respectively.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a vehicle recording system according to according to one or more embodiments shown and described herein;

FIG. 2 schematically depicts a vehicle with the vehicle recording system of FIG. 1 according to one or more embodiments shown and described herein; and

FIG. 3 schematically depicts an illustrative flow chart for operating the vehicle recording system of FIG. 1 according to one or more embodiments shown and described herein.

### DETAILED DESCRIPTION

Embodiments described herein are directed to a vehicle that includes a vehicle recording system. The vehicle recording system includes a first camera, a data memory device, a first controller and a second controller. The vehicle recording system records video and/or image data (“VID”) of an area of a surrounding environment of the vehicle during driving and/or during parking. As such, the VID includes both stationary and non-stationary events that occur in the vehicle surrounding area. For example, a non-stationary event occurring in a preceding vehicle can be pursued and monitored by driving behind the preceding vehicle with a fixed distance.

The second controller, which is configured to control, dependent on an input from a vehicle occupant, an area of a vehicle environment captured by a camera and/or writing VID on a data memory device and/or reading the VID from the data memory device, loss of VID from cameras controlled by an advanced driver assistance systems (“ADAS”) is prevented. The preserved VID may be used for multiple purposes. For example, the preserved VID may be useful or relevant for insurance companies, law enforcement agencies, medical services or personal interest.

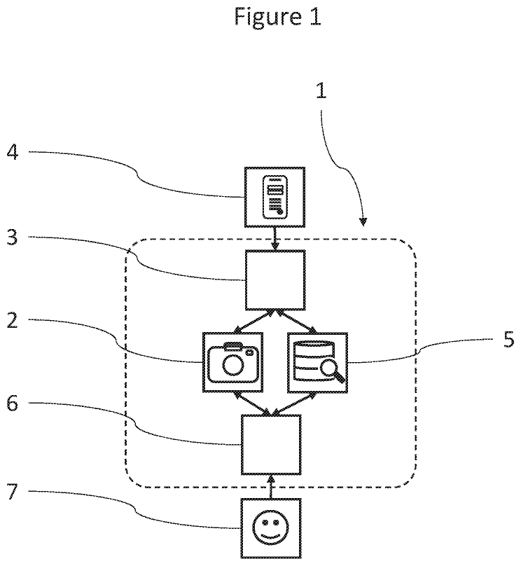

Now referring to FIG. 1, a vehicle recording system 1 is schematically depicted. The vehicle recording system 1 includes a first camera 2, a first controller 3, a data memory device 5, and a second controller 6. The first camera 2 records video and/or image data (VID) of an area of a vehicle surrounding environment 15. The first camera 2 may be a 360° rotatable surround view camera, which is designed to be mounted on a vehicle roof. The data memory device 5 stores the VID. The data memory device 5 may be a hard drive. The first controller 3 controls, dependent on a signal from an Advanced Driver Assistance System (ADAS) 4, the area of the vehicle environment captured by the first camera 2 and/or writing the VID onto the data memory device 5 and/or reading the VID from the data memory device 5. The second controller 6 controls, dependent on an input from a vehicle occupant 7, the area of the vehicle environment captured by the first camera 2 and/or writing the VID onto the data memory device 5 and/or reading the VID from the data memory device 5. The input from the vehicle occupant 7 may be a vehicle starting and/or ignition signal. The first controller 3 and the second controller 6 may be electronic units of a computer. The first controller 3 and the second controller 6 may further be designed to repeatedly trigger the first camera 2 to record VID in regular time intervals.

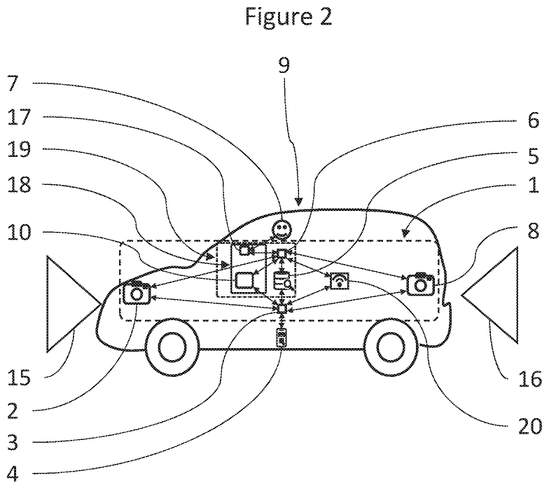

FIG. 2 schematically depicts another aspect of the vehicle recording system 1 within a vehicle 9. It should be understood that like numerals will be used to describe the same features/structures with respect to FIG. 1. The vehicle recording system 1 includes the first camera 2 integrated into a front grill of the vehicle 9 such that the first camera 2 records VID of the area of the vehicle surrounding environment 15, such as a road and/or roadside in front of the vehicle 9.

The vehicle recording system 1 further includes a second camera 8. The second camera 8 is located at the rear side of the vehicle 9 and is positioned to record VID of an area of a vehicle surrounding environment 16, such as the road and/or roadside behind the vehicle 9.

In some embodiments, the first camera 2 and the second camera 8 include wide angle lenses with optical zoom. In this embodiment, both cameras record VID in 1080p high definition quality. As such, the VID recorded by the cameras 2, 8 is of high resolution, even when recorded in close or far distance from the vehicle. As such, the VID is suitable for identifying and/or assessing situations in the vehicle surrounding environments 15, 16, such as emergency situations.

The data memory device 5 may be a built-in hard-drive. The data memory device 5 may be integrated into an information and entertainment system 19 of the vehicle 9. In some embodiments, the data memory device 5 has a memory capacity of 2 TB, which is suitable for storing the recorded VID. In other embodiments, the data memory device 5 has a memory capacity of less than or greater than 2 TB.

The vehicle 9 includes an ADAS 4. The ADAS 4 initiates an emergency braking process for pedestrian protection purposes. The first controller 3, which may be integrated into the vehicle 9 as part of the vehicle recording system 1, receives a signal from the ADAS 4. Dependent on the signal, the first controller 3 controls the area of the vehicle environment 15, 16 captured by the first and second camera 2, 8. In embodiments, the first controller 3 operates autonomously, which enables the first controller 3 and the vehicle recording system 1 to react to a situation. For example, a predicted pedestrian collision, in which the first controller 3 controls the capturing the area of the vehicle surrounding environment 15, 16 of the first or second camera 2, 8 faster than a vehicle occupant 7 could react. Furthermore, the first controller 3 controls writing the VID on the memory device 5 as well as reading and erasing VID from the data memory device 5 dependent on signals from the ADAS 4.

A user panel 17 integrated into the dashboard 18 of the vehicle 9 provides an interface for a vehicle occupant 7 to interact with the second controller 6. In some embodiments, the user panel 17 may be part of the information and entertainment system 19 of the vehicle 9. In other embodiments, the user panel 17 is not part of the information and entertainment system 19. The second controller 6 controls the area of the vehicle environment 15, 16 captured by the first or second camera 2,8, writing the VID on the data memory device 5, reading and erasing the VID from the data memory device 5.

By entering commands for the second controller 6 into the user panel 17, the vehicle occupant 7 is enabled to start and to stop recording VID of selected scenes of the vehicle environment 15, 16. As such, in this embodiment, the vehicle occupant 7 is enabled to selectively surveil situations, including emergency situations from a safe position within the vehicle 9. It thereby provides a technical support for the vehicle occupant 7 for decision-making on how to react to such situations. Furthermore, it enables the vehicle occupant 7 to record scenes of personal interest, such as scenic roads.

By entering commands for the second controller 6 into the user panel 17, the vehicle occupant 7 is enabled to store VID on the memory device 5 and to read VID form the memory device 5. The second controller 6 also enables the vehicle occupant 7 to access VID from the memory device 5, which was autonomously recorded by the first or second camera 2, 8, and stored based on a signal from the ADAS 4. Thereby preservation and availability of the recorded VID is achieved.

The vehicle recording system 1 further includes a display unit 10 that displays the VID in real time or time delayed. In some embodiments, the display unit 10 is integrated into the dashboard 18 of the vehicle 9 in a direct line of sight from the driver position. The real time displaying of the VID may provide a vehicle occupant 7 with information, suitable to assess an emergency situation in the vehicle surrounding area 15, 16, from a safe position within the vehicle 9. The time-delayed displaying of the VID enables assessing situations, including insurance relevant situations, such as fault collision claims, subsequent to their occurrence.

In another embodiment, the vehicle recording system 1 further includes a VID transmitter 20. The first and second controller 3, 6 are configured to share VID with second and third parties through the VID transmitter 20. The second and third parties may be firefighters, law enforcement, medical services, insurances and/or ride share services. In some embodiments, the vehicle 9 may belong to one of the aforementioned departments or services.

In other embodiments, the vehicle 9 includes the vehicle recording system 1, the first camera 2 integrated into the front grill of the vehicle 9 and records the VID of the vehicle surrounding area 15, 16 which is in close proximity to the vehicle 9. The recorded VID is suitable to assist the vehicle 9 or the vehicle occupant 7 during a parking process. While parking, the first controller 3 controls the first camera 2 dependent on a signal from the ADAS 4, such as a parking assistant. The VID may be autonomously stored on the memory device 5.

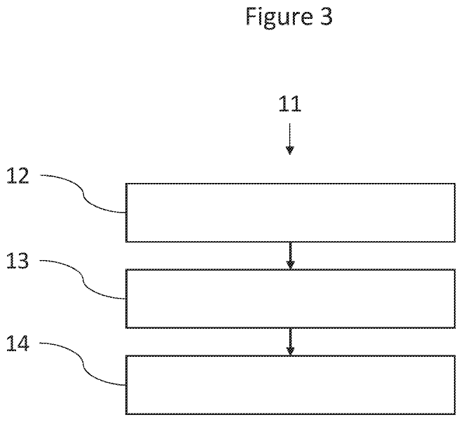

FIG. 3 schematically depicts a flowchart of an illustrative method 11 for operating the vehicle recording system 1. At block 12, the VID of an area of the vehicle surrounding environment is recorded. At block 13, the VID is written 13 on the data memory device 5. At block 14, the VID is read 14 from the data memory device 5. It is understood that blocks 12, 13, 14 of the illustrative method 11 are each controlled by the first and second controllers 3, 6, depending on the signal from an ADAS 4 or the input from the vehicle occupant 7, respectively, as discussed herein.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
an advanced driver assistance system configured to transmit a signal; and
a vehicle recording system comprising:
a first camera that records video or image data of an area of a vehicle surrounding environment;
a hard drive that stores the video or image data;
a first controller that controls, dependent on the signal from the advanced drive assistance system:
the area of the vehicle environment captured by the first camera,
writing the video or image data on the hard drive, and
reading the VID from the hard drive,
a second controller that controls, dependent on an input from a vehicle occupant:
the area of the vehicle environment captured by the first camera,
writing the video or image data on the hard drive, and
reading the video or image data from the hard drive.

2. The system of claim 1, further comprising:
a display that displays the video or image data in real time or time-delayed.

3. The system of claim 1, wherein the first camera records the video or image data, which is suitable for identifying and assessing an emergency situation in the vehicle surrounding environment.

4. The system of claim 2, further comprising:
a second camera,
wherein the first and the second cameras record the video or image data of different areas of the vehicle surrounding environment, and
wherein the first or second controllers control the second camera.

5. The system of claim 1, wherein the first and second controllers are configured to share the video or image data with a second or third party via a transmitter.

6. The system of claim 1, wherein the first camera is configured to record the video or image data that is in close proximity of a vehicle.

7. The system of claim 1, wherein the hard drive is integrated into an information and entertainment system of a vehicle.

8. The system of claim 1, wherein the second controller is configured to enable a vehicle occupant to access and to manipulate the video or image data at the time of recording or subsequent to recording.

9. The system of claim 1, further comprises:
a vehicle, the vehicle having the vehicle recording system, and
wherein the vehicle recording system records the video or image data of the area of the vehicle surrounding environment during driving and during parking.

10. A method of operating a vehicle recording system comprising the steps of:
initiating, by an advanced driver assistance system, a signal;
controlling, by a first controller, a first camera dependent on the signal from the advanced drive assistance system;
capturing, by the first camera, a video or image data of an area of a vehicle surrounding environment;
writing, by the first controller, the video or image data on a hard drive;
reading, by the first controller, the video or image data from the hard drive;
controlling, by a second controller, the first camera dependent on an input from a vehicle occupant;
capturing, by the first camera, the video or image data of the area of a vehicle surrounding environment
writing, by the second controller, the video or image data on the hard drive; and
reading, by the second controller, the video or image data from the hard drive.

11. The system of claim 1 wherein the first camera is mounted on a roof and is configured to rotate 360 degrees.

12. The system of claim 1 wherein the input from the vehicle occupant is an ignition signal.

13. The system of claim 1 wherein the first controller automatically repeatedly triggers the first camera to autonomously and automatically capture images/video of the vehicle environment at regular intervals.
